(19) United States
(12) Patent Application Publication
(10) Pub. No.: US 2015/0067648 A1
(43) Pub. Date: Mar. 5, 2015

(54) Preparing an optimized test suite for testing an application under test in single or multiple environments

(71) Applicant: HCL Technologies Limited, Chennai (IN)

(72) Inventors: ARIVUKARASU SIVANESAN, Chennai (IN); JOHNSON SELWYN, Chennai (IN); DHANYAMRAJU S U M PRASAD, Hyderabad (IN); AKHILESH CHANDRA SINGH, Noida (IN); MADHAVA VENKATESH, Chennai (IN)

(21) Appl. No.: 14/469,613

(22) Filed: Aug. 27, 2014

(30) Foreign Application Priority Data
Aug. 27, 2013 (IN) 3796/CHE/2013

(51) Int. Cl. G06F 11/36

(52) U.S. Cl. CPC G06F 11/3684
USPC 717/124

(57) ABSTRACT

Embodiments herein provide a method and system to create an optimized test suite for software testing. This system fetches required input parameters such as risk parameters, release type of the application, requirement details, test case details, requirement to test case relation and so on automatically using any suitable tool. Then, first level optimized test suite is formed by removing redundant and obsolete test cases from test case set. Further, probability of failure is calculated for each test case either manually or through automation and risk index value for each test case is defined. Further, test cases are classified based on value of risk index obtained. Further, second level optimized test suite is formed by using orthogonal array methodology. Furthermore, final optimized test suite with greater precision is prepared by considering execution time of iteration of all test cases along with their risk index values.

The present application is based on, and claims priority from, IN Application Number 3796/CHE/2013, filed on 27 Aug. 2013, the disclosure of which is hereby incorporated by reference herein.

### TECHNICAL FIELD

The embodiments herein relate to software testing and, more particularly, to create an optimized test suite for software testing.

### BACKGROUND

Before releasing a newly developed software program or application for public use, the developed software must be thoroughly tested in order to eliminate errors. Traditionally, Software testing has been carried out in many ways like adhoc testing, record and play-back testing or testing each functionality through creation of test cases and executing them in either manual or automated mode. As the complexity of software application is increased, the complexity of testing the software application is also increased. The best choice of software testing involves the process of testing each functional element of the software application with all possible test cases. However, this requires a significant amount of time. Further, recent market demands have accounted for quick release of softwares, hence software releases with quality has now become a challenging task as the execution of all test cases in a short span of time is impossible. Also, another problem involved in existing software testing method is that they do not provide suitable means for estimation of testing effort for executing the test cases. This problem arises as the traditional estimating processes like ad-hoc or expert judgment sometimes misguides the planning phase and results in effort over-run during the execution phase of given test suite.

What is needed therefore is a system and method which enhances the quality of testing by preparing an optimized test suite for testing the given application in single or multiple environments.

### SUMMARY

In view of the foregoing, an embodiment herein provides a method of optimizing test suite for an application. The method comprises fetching a test suite corresponding to the application. Further, a first optimized test suite is created corresponding to the fetched test suite and Risk Index (RI) value for a plurality of test cases in the first optimized test suite is calculated. Further, a second optimized test suite is created from the first optimized test suite using an orthogonal array optimization and a final optimized test suite is created from the second optimized test suite.

Embodiments further disclose a system of optimizing test suite for an application. The system is provided with means for fetching a test suite corresponding to the application using an optimization server. Further, the system creates a first optimized test suite corresponding to the fetched test suite and calculates Risk Index (RI) value for a plurality of test cases in the first optimized test suite using the optimization server. Further, a second optimized test suite is created from the first optimized test suite using an orthogonal array optimization using the optimization server and a final optimized test suite is created from the second optimized test suite using the optimization server.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a general block diagram of the test case optimization system, as disclosed in the embodiments herein;

FIG. 2 illustrates a flow diagram which shows various steps involved in the process of testing a software application using an optimized test suite, as disclosed in the embodiments herein; and

FIG. 3 illustrates a flow diagram which shows various steps involved in the process of preparing an optimized test suite, as disclosed in the embodiments herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

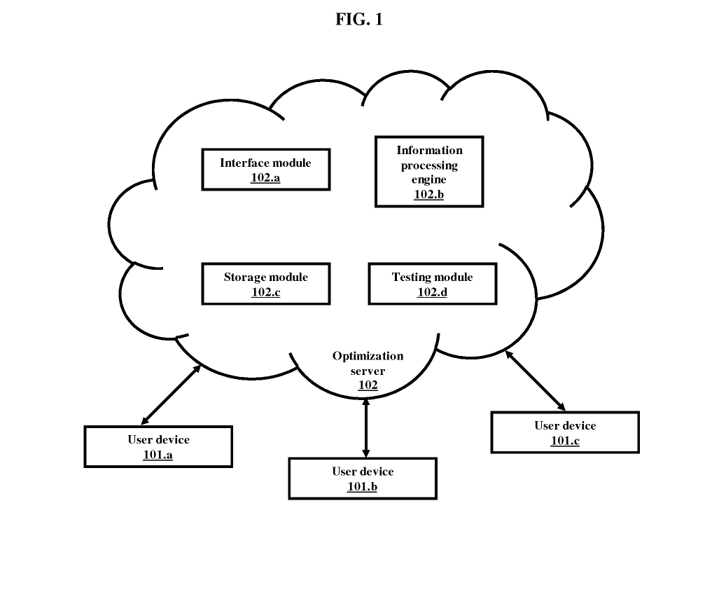

The embodiments herein disclose a system and a method to enhance the quality of testing a software application by preparing an optimized test suite. Referring now to the drawings, and more particularly to FIGS. 1 through 3, where similar reference characters denote corresponding features consistently throughout the figures, there are shown embodiments.

FIG. 1 illustrates a general block diagram of the test case optimization system, as disclosed in the embodiments herein. The system comprises a plurality of user devices 101 and an optimization server 102. The optimization server 102 further comprises an interface module 102.a, an information processing engine 102.b, a storage module 102.c and a testing module 102.d.

The user device 101 can be any type of commonly available computing devices like personal computer, laptop, tablet etc. which is capable of fetching input from user by providing a suitable interface like keyboard, mouse, touch screen etc. By using this user device 101, the user can manually provide any required input information to the optimization server 102. The user device 101 further receives processed output information from optimization server 102. Finally, this processed output information is provided to the user through a suitable output interface such as a display screen.

The interface module 102.a present in the optimization server 102, acts as an interface between optimization server 102 and the user device 101. The interface module 102.a receives input information from user device 101 and communicates this information to the information processing engine 102.b for further processing of the information. Later, the interface module 102.a fetches the processed output from information processing engine 102.b and delivers the processed output to user device 101 by providing a suitable user interface.

The information processing engine 102.b, based on input fetched from the interface module 102.a, processes the fetched input using different optimization techniques and produces a final optimized output i.e. an optimized test suite. This final optimized output will be stored in a storage module 102.c for future reference. Further, the optimized test suite is sent to the testing module 102.d; which then executes the application with test cases from final optimized test suite. In another embodiment, the application testing can be done manually by the user with final optimized test cases. Further, the test results are sent to the interface module 102.b, which in turn displays the results to the user using a suitable interface. The test results may be then stored in a database associated with the storage module 102.c. Further, the storage module 102.c is capable of providing the stored information whenever the information processing engine 102.b requests it. In an embodiment, the storage module 102.c may fetch the data required for optimization process from any external database such as a test management suite tool. In another embodiment, the storage module 102.c may store data required for optimization process as provided by a user through a suitable user interface provided by the interface module 102.a.

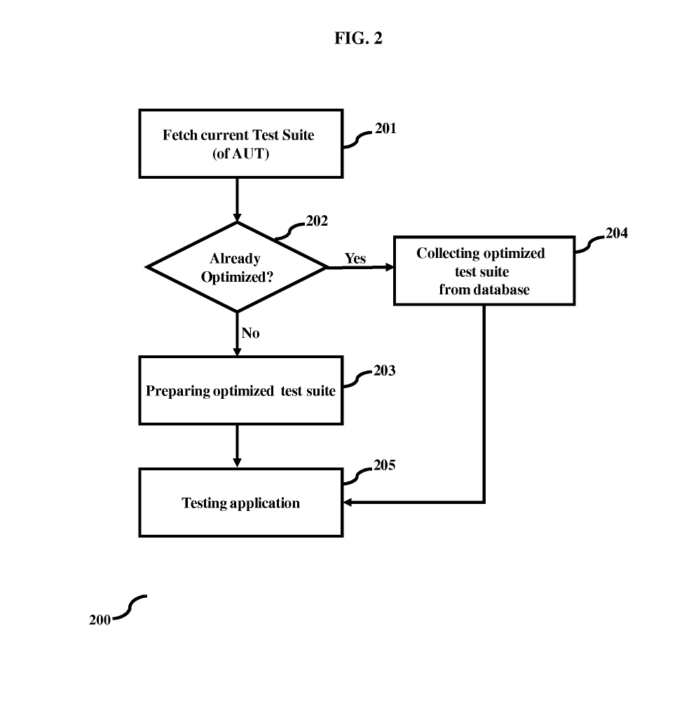

FIG. 2 illustrates a flow diagram which shows various steps involved in the process of testing a software application using an optimized test suite, as disclosed in the embodiments herein. The optimization server 102 receives the application to be tested or Application Under Test (AUT) through the user device 101 using an interface module 102.a. Then, the optimization server 102 fetches (201) a test suite that belongs to current AUT, from the storage module 102.c of optimization server 102. Further, the information processing engine 102.b checks (202) whether the current test suite of the application under test (AUT) has already been optimized by the system or not. In a preferred embodiment, information regarding previously optimized test suites is stored in the storage module 102.c. If the test suite is found to be tested previously, then the information processing engine 102.b collects (204) the stored optimized test suite form the storage module 102.c for testing the input application.

If the test suite is not tested by the system before, then the information processing engine 102.b prepares (203) an optimized test suite specific to the AUT .The information processing engine 102.b may consider various parameters such as functionalities of the application, platform on which the application has been built and so on. Finally, the optimization server 102 tests (205) the input application using this optimized test suite and communicates the result to user device 101 through the interface module 102.a.The various actions in method 200 may be performed in the order presented, in a different order or simultaneously. Further, in some embodiments, some actions listed in FIG. 2 may be omitted.

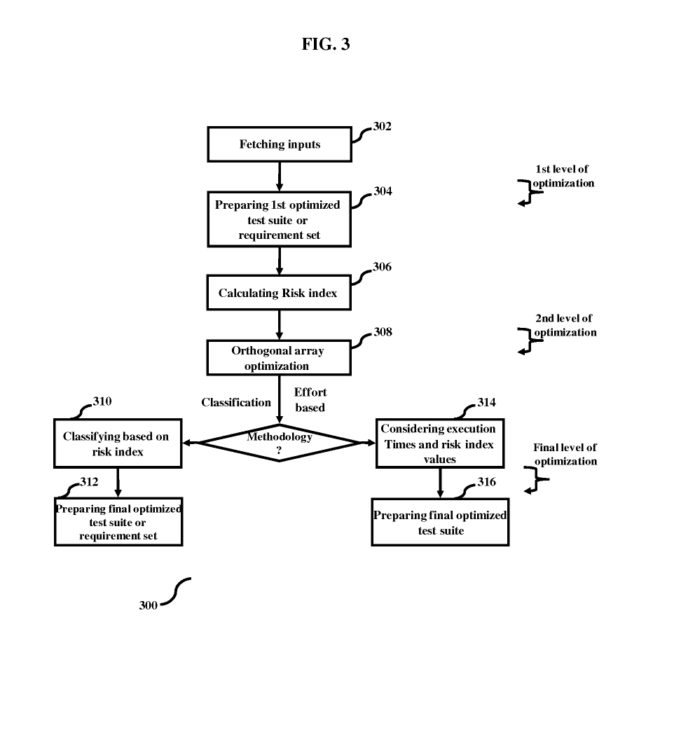

FIG. 3 illustrates a flow diagram which shows various steps involved in the process of preparing an optimized test suite, as disclosed in the embodiments herein. The information processing engine 102.b fetches (302) the required inputs such as the requirements, test cases, test data sets, requirements-to-methods traceability, impact of failure, test case execution complexity from storage module 102.c. Further, values of partial of risk parameters can be fetched through automation tools and values of other risk parameters from the user through the interface module 102.a. Furthermore, the user can manually select the method of optimization by selecting the type of the release of the AUT being planned currently and total budgeted testing time for this current release in order to form the final level optimized test suite through the user device 101. The optimization server 102 provides at least two methods for final optimized test suite selection (namely classification method and effort based method) and a suitable method may be selected based on requirements of the user.

The risk parameter can be one of the factors related to an application that indicates potential failure of any functionality of the application or the application as a whole. Hence, the probability of failure of a particular functionality of the application can be used to determine the probability of occurrence of one or more of the risk parameters. For example, Complexity, Requirement maturity, Frequency of Requirement Change, etc. can be considered as risk parameters for a particular application. The risk parameters of a particular application can be pre-determined as they are specific to each domain or application-type or a combination of domain-application type. For example specific risk parameter values may be measured and assigned to applications in various domains such as aerospace, health-care, embedded and so on. A value for some or all the risk parameters for the input application is to be identified and the impact of each risk parameter for each test case has to be entered by using the user device 101. For example, the risk parameter ‘code change’ may have specific values corresponding to a changed or unchanged status of the related code; whereas, the risk parameter ‘new technology’ may have specific values corresponding to new, partially new, and old status of the technology. Depending upon the type of risk parameter, the user can input the risk parameter value either manually or automation by using a storage module 102.c of optimization server 102.

Application Release type is another parameter used determining the test suite for execution. In order to identify or prioritize the right kind of test cases for execution quickly, the respective release type needs to be identified. For example, application release types are major release or minor release that might carry a few enhancements or few new features, and may be patch release that might carry a bug fix in certain portion of the application. Each release type definition carries a weightage i.e. release weightage for each risk parameter identified. These weights are defined in percentage value r (W) which is retrieved from the storage module 102.c. In another embodiment, the weights can be entered manually through user device 101 against each risk parameter.

Further, the optimization server 102 may fetch information regarding requirement details, test case details and requirements to test case relations and so on, automatically from storage module 102.c. In another embodiment, information regarding requirement details, test case details and requirements to test case relations can be imported from the files of type MS Excel, CSV, TXT, etc. The optimization server 102 may also fetch details of probability of occurrence of each risk factor. In another embodiment, the probability of occurrence of each risk factor can be indicated using a string value like Very High, High, Medium and Low. Each string value in turn is assigned a numeric value in the background for calculation purpose. For example, for risk parameter complexity, the values can be very high, high, medium and low with numeric values 5, 4, 3 and 1 respectively.

The information processing engine 102.b after fetching all the required inputs, identifies the redundant and obsolete test cases by using test case code coverage reports and historic results of each test case that are present in the test case set through automation and with a confirmation from the user. Further, a first level of optimization is done by removing all the redundant and obsolete test cases from the test case set and finally a first optimized test suite is formed (304).

After forming the first optimized test suite, probability of failure P (F) and risk index values are calculated (306) by using risk parameter values and sum of maximum risk parameter values which are defined for a particular test case. In an embodiment, the probability of failure P (F) value can be fetched automatically from storage module 102.c of optimization server 102. In another embodiment, the probability of failure P(F) value may be calculated using the equation given below:

P(F)={Σ(Risk Parameter Values*r(W)/100)/Σ(Max. (Risk Parameter Value))} (1)

Further, the risk index for a particular test case is calculated by using Probability of failure P (F) and Impact of failure I (F). The factor impact of failure I (F) can be automatically fetched from the storage module 102.c where the user generally enters the complexity of the test case/requirement while adding a new test case/requirement. This value can be interpreted for Impact of failure I (F).

RI={P(F)×I(F)} (2)

In general, to test a particular functionality, several set of test data is created for all permutation and combination of rules applied to test the functionality. In addition, if it is a multi-environment, the entire test set executed in one environment will typically have to be repeated in other environments. An array of the test data set for each of the functionality is first added to this system either manually or retrieved by connecting to an external application that prepares the test data set for all permutation and combinations. In an embodiment, the user may define rules in the external application based on his/her requirements. Further, a second level of optimization is carried out on the test data set of each of the test cases by using orthogonal array optimization technique (308) and forms a second level optimized test suite. Later, final optimized test suite may be formed by using either classification method or effort based method depending on the user input.

In the Classification method, requirements or test cases are classified (310) based on risk index values calculated for each of them. These classes are string values that are associated with a range of values i.e. a higher threshold and a lower threshold. For example, classifications may be as shown below:

| Classification | Upper Range | Lower Range |
|---|---|---|
| Critical | 5.0 | 4.0 |
| High | 4.0 | 3.0 |
| Medium | 3.0 | 2.0 |
| Low | 2.0 | 1.0 |

Each requirement or test case risk is classified based on corresponding risk index value. For example, a test case that has a risk index value of 4.5 is classified as ‘Critical’ risk as the ‘Critical’ category range is between 4.00 and 5.00. Further, a final optimized test suite or a final optimized requirement set (312) is prepared by selecting the test cases in the order of high risk values to low risk values. For example, the test cases under critical classification are selected first as risk index values of these test cases (lies between 5.00 and 4.00) are higher when compared to other test cases.

If the effort based method is chosen, execution times corresponding to each test case is collected (314) and are classified based on whether they had already been executed in any of the previous releases of the application under test or not. For all the test cases that have been executed in any of the previous builds, actual execution time is collected from the storage module 102.c. For the test cases that are new or never been executed in the past, execution times or execution effort are collected automatically from storage module 102.c based on the complexity of the test case. In an embodiment, the complexity-to-effort chart is prepared once manually by the test manager based on his expert judgment and reused across all the test execution. However, the complexity-to-effort chart may be revisited by the test manager as when he thinks appropriate; the change may be based on statistics that he collects using the previous test cases executed. For example, ‘high’ complexity can take 15 min. For execution (per data set) and ‘low’ can take 5 min. for execution. Further, final execution times can be calculated considering test data sets of each test case that are resulted after applying orthogonal array optimization and are stored in storage module 102.c for future reference. For example, if a test case has 6 test data set and per execution takes 10 minutes, then the effort for testing test case in this release will be (10 min.×6 test data set)=60 min.

Later, the test cases are ordered descending based on the risk index value and execution time of each test case. The budgeted testing effort indicates total time available for testing a planned release version of the application under test (AUT). Further, based on the budgeted testing effort, the test cases are selected one by one in the order of top to bottom until the sum of execution time of those test cases are less than or equal to the total time available for testing. When the condition is met, the selected test cases are generated as final optimized test suite (316). The various actions in method 300 may be performed in the order presented, in a different order or simultaneously. Further, in some embodiments, some actions listed in FIG. 3 may be omitted.

For example, let us consider an application X with following details:

| Sl. | | | No. of Data | | Risk |
|---|---|---|---|---|---|
| No. | Test Case Name | Status | Set | Complexity | Index |
| 1. | Login | Old | 10 | Trivial | 5.0 |
| 2. | Dashboard | Old | 30 | Trivial | 3.0 |
| 3. | Check Balance | Old | 16 | Medium | 1.0 |
| 4. | Withdraw money | Old | 10 | High | 5.0 |
| 5. | Transfer Money | New | 5 (approx.) | High | 1.0 |
| 6. | Bill Payment | New | 10 (approx.) | High | 2.0 |

In the above case, application X contains 6 test cases which have different number of data sets. Further, the number of data set for each test case is based on the current release planned. For example, for the Test Case—1, the number of test data set could be 5 in release—1, 8 in release—2 and 12 in release—3. For each test case Risk Index value is calculated using Probability of failure P (F) and Impact of failure I (F) of each test case.

Let the method selected is effort based. So test cases are classified based on whether they had already been executed in any of the previous releases of the application under test or not. If we consider the test cases from 1 to 4, these are already executed test cases. So their execution times are calculated as follows:

Let us consider one test case (say test case—1 of Release type—1), let it contains 5 test data set. Time for each test data set execution is previously known as they are already executed. Now, the average execution time of each test data set can be calculated. This is shown below:

| Test Data Set | Time for Execution |
|---|---|
| 1 | 10 min. |
| 2 | 12 min. |
| 3 | 6 min. |
| 4 | 14 min. |
| 5 | 8 min. |
| Time for execution of 1 | =(10 + 12 + 6 + 14 + 8)/5 = 10 min. |
| data set of Test Case − 1 | |

The total time for executing this test case is summing up to 50 min. So, the average is 10 min. for a test data to get executed. The average is taken at the test data set level, since not all times the data set can remain the same. If we consider, a test case in different release types, ‘Estimated time for current testing’ (per data set) can be calculated as:

| | | | | Estimated time for |
|---|---|---|---|---|
| | Release | | | current testing |
| Test Cases | Release-1 | Release-2 | Release-3 | (per test data set) |
| Test Case − 1 | 10 min. | 8 min. | 12 min. | =(10 + 8 + 12)/ |
| (execution time | | | | 3 = 10 min. |
| per data set) | | | | |

The “Estimated time for current testing (per test data set)” will be used to estimate the effort for the current release planned. This average time will again be multiplied with the number of test data set for the respective test case in this current release. For example, if test case—1 has 6 test data set, then the effort for testing test case—1 in this release will be (10 min. x 6 test data set)=60 min. For the test cases which are never been executed (test cases 5 and 6 in this example), the testing effort will be calculated based on the complexity of the test case.

After calculating testing effort, the test cases will be re-ordered as shown below. The first ordering will be based on the ‘Risk Index’ and the second ordering will be based on ‘Total Test Case Execution Time’.

| | | | | | Execution | | |
|---|---|---|---|---|---|---|---|
| | | | | | Time/ | Total TC | |
| Sl. | | | No. of | | Test Data | Execution | Risk |
| No. | Test Case Name | Status | Data Set | Complexity | Set | Time | Index |
| 1. | Login | Old | 10 | Low | 5 | 50 | 5.0 |
| 4. | Withdraw money | Old | 10 | High | 17 | 170 | 4.5 |
| 2. | Dashboard | Old | 30 | Low | 6 | 180 | 3.0 |
| 3. | Check Balance | Old | 16 | Medium | 11 | 176 | 1.0 |
| 6. | Bill Payment | New | 10 | High | 16 | 160 | 1.0 |
| | | | (approx.) | | | | |
| 5. | Transfer Money | New | 5 | High | 15 | 75 | 1.0 |
| | | | (approx.) | | | | |

Further, final optimized test suite will be selected based on budgeted testing time. For example if a budgeted testing time of 750 min. is given as input, then all the test cases except 5 will be executed (since the other test cases account for 736 min).

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The embodiment disclosed herein specifies a system for software testing. The mechanism allows creating an optimized test suite for every input application, providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiments may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method of optimizing test suite for an application, said method comprises:
fetching a test suite corresponding to said application;
creating a first optimized test suite corresponding to said fetched test suite;
calculating Risk Index (RI) value for a plurality of test cases in said first optimized test suite;
creating a second optimized test suite from said first optimized test suite using an orthogonal array optimization; and
creating a final optimized test suite from said second optimized test suite.

2. The method as in claim 1, wherein information on said fetched test suite, risk parameter corresponding to said application and release type of said application are pre-configured.

3. The method as in claim 1, wherein creating said first optimized test suite corresponding to said fetched test suite further comprises removing a plurality of redundant and obsolete test cases from said fetched test suite.

4. The method as in claim 1, wherein said RI value is measured based on at least one of a probability of failure value and an impact of failure value.

5. The method as in claim 4, wherein said probability of failure value is calculated based on a release weightage value of each risk parameter associated with said application.

6. The method as in claim 4, wherein said probability of failure value and said impact of failure value are pre configured.

7. The method as in claim 1, wherein said final optimized test suite is prepared using at least one of a classification method or an effort based method.

8. The method as in claim 7, wherein said creating final optimized test suite using said classification method further comprises optimizing said second test suite based on Risk Index values of a plurality of test cases in said second optimized test suite.

9. The method as in claim 7, wherein said creating final optimized test suite using said effort based method further comprises optimizing said second test suite based on at least one of a Risk Index values and corresponding execution time of a plurality of test cases in said second optimized test suite.

10. A system of optimizing test suite for an application, said system provided with means for:
fetching a test suite corresponding to said application using an optimization server;
creating a first optimized test suite corresponding to said fetched test suite;
calculating Risk Index (RI) value for a plurality of test cases in said first optimized test suite using said optimization server;
creating a second optimized test suite from said first optimized test suite using an orthogonal array optimization using said optimization server; and
creating a final optimized test suite from said second optimized test suite using said optimization server.

11. The system as in claim 10, wherein said optimization server provides means for pre-configuring information on said fetched test suite, risk parameter corresponding to said application and release type of said application with a storage module.

12. The system as in claim 10, wherein said optimization server is further configured for creating said first optimized test suite corresponding to said fetched test suite by removing a plurality of redundant and obsolete test cases from said fetched test suite using an information processing engine.

13. The system as in claim 10, wherein said optimization server is further configured for measuring said RI value based on at least one of a probability of failure value and an impact of failure value using an information processing engine.

14. The system as in claim 13, wherein said information processing engine is further configured to calculate said probability of failure value based on a release weightage value of each risk parameter associated with said application.

15. The system as in claim 13, wherein said optimization server further provides means for pre-configuring said probability of failure value and said impact of failure value with a storage module using an interface module.

16. The system as in claim 10, wherein said optimization server is configured for preparing said final optimized test suite using at least one of a classification method or an effort based method using an information processing engine.

17. The system as in claim 16, wherein said information processing engine is further configured for creating said final optimized test suite using said classification method by optimizing said second test suite based on Risk Index values of a plurality of test cases in said second optimized test suite.

18. The system as in claim 16, wherein said information processing engine is further configured for creating said final optimized test suite using said effort based method by optimizing said second test suite based on at least one of a Risk Index values and corresponding execution time of a plurality of test cases in said second optimized test suite.
